(19) United States
(12) Patent Application Publication
(10) Pub. No.: US 2007/0212160 A1
(43) Pub. Date: Sep. 13, 2007

(54) Golf ball position marker

(76) Inventor: Steven Barry Buzil, Westchester, IL (US)

Correspondence Address: GREENBERG TRAURIG, LLP, 77 WEST WACKER DRIVE, SUITE 2500, CHICAGO, IL, 60601-1732, US

(21) Appl. No.: 11/369,757

(22) Filed: Mar. 7, 2006

(51) Int. Cl. B43K 7/10; B43K 7/00

(52) U.S. Cl. 401/214; 401/209

(57) ABSTRACT

A golf ball position marker, for the controlled release of a marking powder, when the marker is pressed against the surface of turf. The marker includes a cylindrical marker body for holding a quantity of marking powder. A spherical dispensing member is biased against an end of the marker body, adjacent a dispensing opening, which has a diameter less than the diameter of the spherical body. A removable closure, distal to the dispensing opening, permits refilling of the marker. The marker is configured so that a biasing member is retained entirely within the marker body, when the removable closure is removed from the marker body.

### BACKGROUND OF THE INVENTION

1. The Technical Field

The present invention relates to marking devices for clearly marking the position of a golf ball on a putting green or other location on a golf course, to enable the golf ball to be temporarily moved, such as to be cleaned or to make room for another golfer's ball to pass as during putting where the first ball might lie in the path between the second ball and the cup, and then thereafter returned to its original position on the putting green.

2. The Prior Art

Golf ball position marking devices are well known. One such early device took the form of a simple spike, having a tab or tag affixed thereto, which was pushed into the turf. Such a device is disclosed in Davis, U.S. Pat. No. 1,716,261.

Another marking method employed by golfers involving placing a flat token or disc on the turf, in lieu of physically disrupting the surface of the turf. Such a marker is disclosed in Kaymen, U.S. Pat. No. 4,530,500. However, in the event that the placement of the token or disc was in the direct path of another golfer's ball, obviously it would have the potential for deflecting the other golfer's ball in its movement, so that use of such a marker could be problematic.

Another marking method disclosed in the prior art is the use of powder-based marking devices which are configured to be pressed to the surface of the turf, at which time a small quantity of a contrasting colored powder would be released, indicating, with reasonable precision, the location of the ball, without physically marring the surface of the turf or leaving a three-dimensional object laying on the turf. Preferably, the powder would be inert, non-toxic and/or otherwise harmless to the environment, such as talcum powder, and thus would gradually disperse, or dissolve when it next rained or when the turf was watered by a sprinkler system or mowed, so as to be quickly no longer visible.

Spellmeyer, U.S. Pat. No. 1,756,141 discloses a marker that is built in to the handle of a golf club. The marker body houses a spring-biased conical member biased against a dispensing opening in the marker body, which has a diameter that is less than the diameter of the conical member at a position midway along its length. The opposite end of the marker body is a threaded aperture which receives a threaded plug or projection on the shaft of the club. A quantity of powder is capable of being stored in the marker body. Surrounding the opening, on the end of the marker body are three projections, or in an alternative embodiment, an annular ridge. A degree of force must be applied to the club to force the projections or ridge into the surface of the turf before contact will be made between the conical member and the turf to, in turn, push the conical member upwardly overcoming the force of the spring, to enable a small quantity of powder to fall in the annular gap thus created between the conical member and the edge of the dispensing opening.

Eckert, U.S. Pat. No. 2,892,633 discloses a marker that is built into the head of a golf club. A bore, for storing the powder, is formed lengthwise through the head, with a slotted, threaded plug forming a closure at one end of the bore, nearest the shaft of the club. The other end of the bore intersects at an angle with a dispensing bore which leads to a dispensing opening, pointing downwardly. A spherical member, having a greater diameter than the diameter of the dispensing opening, is spring-biased in the dispensing bore, against the edge of the dispensing opening. In an alternative embodiment, the powder storage bore does not extend the length of the head, but extends at an upward angle in the head and intersects the dispensing bore at a shallow included angle.

Bragg, U.S. Pat. No. 4,553,752 discloses another marker device built into the handle of a club, in which bristles extend from the end of the handle and serve to actuate the release of powder.

Hultquist, US Pub. No. 2003/0148832 A1 and U.S. Pat. No. 6,692,373 B2 both disclose a powder based marker device, which may take the form of a hand-held device or which may be built into the end of a club or pole, wherein a spring-biased spherical member is held in place by a removable cap having a dispensing opening (having a diameter that is smaller than the diameter of the spherical member). When the cap is removed, which is necessary to refill the devise with powder, the spring serving to bias the spherical member and the spherical member itself may each be ejected. Care must be taken to prevent the spring and sphere from being damaged or lost.

Kvitek, U.S. Pat. No. 6,699,144 B1; US Pub. No. 2004/0092340 A1; and U.S. Pat. No. 6,942,584 B2, each discloses combination golf tools, having a powder based marker and a divot repair tool. In each of the disclosed designs, the spherical member that alternatively releases or contains the powder is held in place by a removable threaded cap, that also serves to provide access to the interior of the device, for refilling purposes. The '584 patent also discloses an alternative structure in which a powder marking cartridge has a removable threaded cap mounted on an end of the marker body distal to a spring biased dispensing member, which has a rounded conical configuration.

Another prior art position marker device is being offered for sale under the name EZ MARKER, by EZ Mark, Inc. A version of this device appears to be the subject of US Des. 306,874. As is best understood, the construction of this device includes a generally cylindrical body, having a uniform interior diameter and threaded plug closure at one end, and a dispensing opening at the other end. A helical spring retained inside the body presses against the inside surface of the threaded plug closure at one end, and at its other end, bears against a spherical member sealing the dispensing opening. The spherical member is prevented from passing through the dispensing opening end of the body by virtue of the fact that the portion of the body in the vicinity of the dispensing opening, which is conical or radially inwardly beveled, has been mechanically reduced in diameter, so that the radially inwardmost lip of the dispensing opening has a diameter which is less than the diameter of the spherical body. Otherwise, the interior diameter of the marker body is essentially constant along its length. When the threaded plug closure is removed from the marker body, the end of the spring is promptly ejected from the body, and care must be taken to prevent the spring and spherical member from falling from the body and/or the sudden expansion of the spring causing a quantity of the powder to be ejected, and thus causing waste and an undesirable mess, and even possible loss of the spring and/or spherical member, not to mention the nuisance of having to reassemble the device.

It would be desirable to provide a golf ball position marker device, which has a simplified configuration which prevents undesired release of powder or loss of the spring component, such as during refilling.

This and other desirable characteristics of the present invention will become apparent, in view of the specification, including the claims, and drawings.

### SUMMARY OF THE INVENTION

The present invention comprises a golf ball position marker, for enabling the controlled release of a powder substance to indicate the position of a golf ball. The golf ball position marker comprises a substantially cylindrical marker body. The marker body has a longitudinal bore therethrough, terminating in a dispensing aperture at one end of the marker body, and a refilling aperture at an opposite end of the marker body.

The cylindrical bore has a first portion having a predominant first diameter, and a second portion, having a predominant second diameter, less than the predominant first diameter of the first portion, so as to define an annular shoulder on an inner surface of the marker body, disposed between the first portion and the second portion of the cylindrical bore.

A dispensing member is disposed in the first portion of the cylindrical bore, the dispensing member having a third diameter, a region of the first portion adjacent the dispensing aperture having a fourth diameter which is less than the third diameter of the dispensing member.

A biasing member is disposed in the first portion of the cylindrical bore, between the annular shoulder and the dispensing member, for prompting the dispensing member toward the dispensing aperture.

A closure member is operably configured to be removably affixable to the marker body, adjacent the refilling aperture.

In a preferred embodiment of the invention, the dispensing member is a spherical member.

Preferably, the biasing member is a spring, in particular, a helical spring, having circular loops at opposite ends thereof, operably configured to bear, respectively, against the annular shoulder and the dispensing member.

A region of the second portion of the cylindrical bore is preferably internally threaded, and the closure member has an externally threaded portion, configured to threadably mate with the internally threaded portion of the region of the second portion of the cylindrical bore.

### BRIEF DESCRIPTION OF THE DRAWINGS

FIG. 1 is a side elevation of the marker according to a preferred embodiment of the invention.

FIG. 2 is a view of the dispensing end of the marker according to the embodiment of FIG. 1.

FIG. 3 is a perspective view of the dispensing end of the marker according to the embodiment of FIGS. 1 and 2.

FIG. 4 is an exploded side elevation of the marker according to the embodiment of FIGS. 1-3.

### DETAILED DESCRIPTION OF THE INVENTION

While this invention is susceptible of embodiment in many different forms, there is shown in the drawings and will herein be described in detail, a preferred embodiment with the understanding that the present disclosure should be considered as an exemplification of the principles of the invention and is not intended to limit the invention to the embodiment so illustrated.

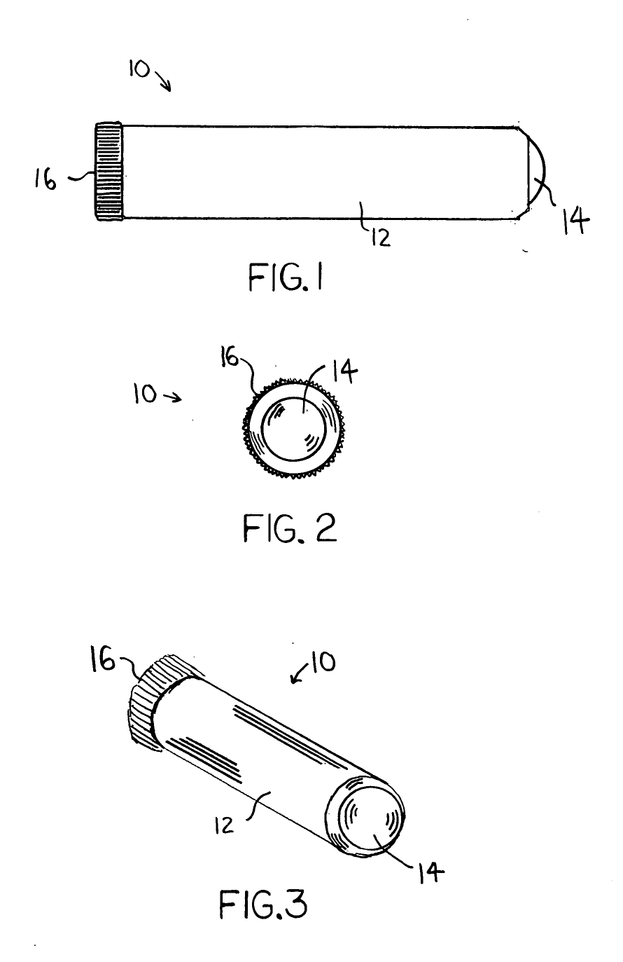

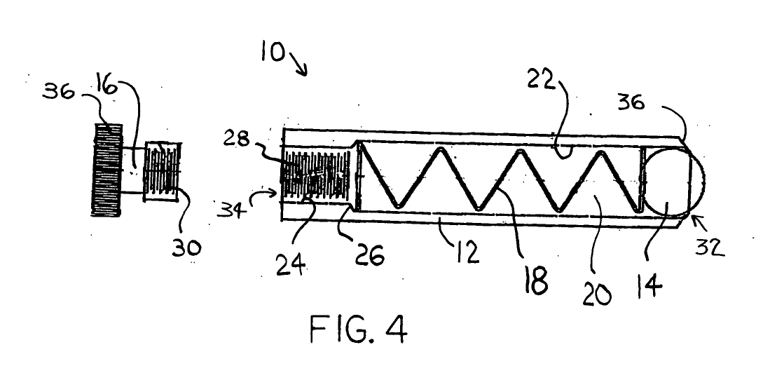

Making reference to FIGS. 1-4, marker apparatus 10 comprises a substantially cylindrical marker body 12, spherical dispensing member 14, closure 16, and biasing member 18.

In a preferred embodiment of the invention, marker body 12 and closure 16 are fabricated from a metal material, such as steel, aluminum, brass, etc., although they may also be fabricated from any other durable material, such as plastic, resin, ceramic and the like. Preferably, the material will be one that will not rust, oxidize, or crack or craze with age. Spherical member 14 is preferably in the form of a stainless steel ball bearing, although other materials may be used as well. Biasing member 18 is preferably a helical steel spring, having circular loops at its ends, so as to exert uniformly distributed pressure on the marker body, and on the spherical member, as described in further detail herein.

Cylindrical marker body 12 has a longitudinal bore 20, which has a first portion 22, having a first diameter, and a second portion 24, which has a smaller diameter than the first portion, thus producing an inner shoulder 26. The inner surface of second portion 24 is threaded at 28, to mate with threaded portion 30 on closure 16. Bore 20 terminates, at one end, in dispensing aperture 32, and refill aperture 34.

A method according to the present invention includes forming longitudinal bore 20 by forming body 12 of a cylindrical material having an interior diameter substantially equivalent to second portion 24, tapping threads 28, boring first portion 22 having the larger diameter portion, thereby forming shoulder 26 which serves to retain biasing member 18 and spherical member 14 within body 12 at all times. Alternatively, threads 28 may be formed into second portion 28 after the first portion 22 has been bored into body 12. In a still further embodiment, closure 16 could be formed of a substantially hard material having threads formed therein which serve to self-tap and form threads 28 into first portion 22 of body 12. Of course, the use of non-metal materials lend themselves to other methods of manufacture which are deemed within the scope of the present invention.

To maintain spherical member 14 within marker body 12, the end of marker body 12 adjacent dispensing aperture 32, will preferably be beveled at 36, and will have been formed to have an inner diameter that is, however slightly, less in diameter that the diameter of spherical member 14. A preferred method for producing the reduction in diameter is to subject the outer surface of marker body 12, in the vicinity of dispensing aperture 32 to mechanical working, such as swaging or spinning, to reduce the overall diameter, and simultaneously the inner diameter, of the end of marker body 12 adjacent dispensing aperture 32. Biasing member 18 and spherical member 14 are inserted into portion 22, and held in place, prior to such swaging or spinning process.

Because biasing member 18 is maintained in a continuously compressed state, between shoulder 26 and spherical member 14, there is no danger of undesired ejection of either biasing member 18 or any residual powder (not shown) that may be left inside marker body 12, when closure 16 is removed for refilling purposes. Preferably, closure 16 has a reeded (as shown) or knurled knob 36 for facilitated grasping and turning, especially if the user is wearing golf gloves. An additional embodiment of the present invention contemplates a short tether affixed to the inner surface of closure 16 and body 12 to further prevent loss thereof.

In operation, the present marking device may be carried by a golfer and used to mark the position of a golf ball on a putting green by holding the device in a substantially vertical position and pressing it against the turf immediately adjacent the current position of the golf ball. The user need only apply enough force to overcome the force being exerted by the spring biasing member 18 on the spherical member 14 whereby the spherical member 14 will effectively retract into body 12 permitting a small quantity of powder to fall from body 12 and deposit on the turf leaving a mark visible to the golfer indicating the position of the ball. The ball may then be removed and thereafter replaced at the very spot same spot. It is within the scope of the present invention that the each member of a group of golfers could be provided with a device having a different colored powder to differentiate each golfer's marks on the putting green. A color coded band on the exterior of body 12 could indicate the powder color therein. The construction of the present invention particularly lends itself to such flexibility as one can readily change colored powder without fear of loosing the internal parts of the device, namely the biasing member 18 or spherical member 14. One need only remove closure 16 and shake out any remaining powder.

Likewise, it will be appreciated that the present inventive marking device permits one to refill the powder reservoir with additional powder at any time. One need not wait until the reservoir is empty or risk wasting powder remaining therein, nor risk losing or damaging the spring biasing member 18 or spherical member 14. One does not have to deal with possibly dropping the biasing member 18 onto dew laden grass only to then dampen the powder upon reassembly possibly impairing operation of the device by clumping up the powder stored therein. Instead, the vital components are retained in place wholly within the body of the device safe from loss and damage.

The foregoing description and drawings merely explain and illustrate the invention, and the invention is not so limited as those skilled in the art who have the disclosure before them will be able to make modifications and variations therein without departing from the scope of the invention.

1. A golf ball position marker, for enabling the controlled release of a powder substance to indicate the position of a golf ball, comprising:
a substantially cylindrical marker body, for containment of a preponderance of said powder substance,
the marker body having a longitudinal bore therethrough, terminating in a dispensing aperture at one end of the marker body, and a refilling aperture at an opposite end of the marker body,
the cylindrical bore having a first portion having a predominant first diameter, and a second portion, having a predominant second diameter, less than the predominant first diameter of the first portion, so as to define an annular shoulder on an inner surface of the marker body, disposed between the first portion and the second portion of the cylindrical bore;
a dispensing member, disposed in the first portion of the cylindrical bore, the dispensing member having a third diameter, a region of the first portion adjacent the dispensing aperture having a fourth diameter which is less than the third diameter of the dispensing member;
a biasing member, disposed in the first portion of the cylindrical bore, between the annular shoulder and the dispensing member, for prompting the dispensing member toward the dispensing aperture; and
a closure member, fabricated substantially entire as a substantially rigid structure, operably configured to be removably affixable to the marker body, adjacent the refilling aperture.

2. The golf ball position marker according to claim 1, wherein the dispensing member is a spherical member.

3. The golf ball position marker according to claim 1, wherein the biasing member is a spring.

4. The golf ball position marker according to claim 3, wherein the spring is a helical spring, having circular loops at opposite ends thereof, operably configured to bear, respectively, against the annular shoulder and the dispensing member.

5. The golf ball position marker according to claim 1, wherein a region of the second portion of the cylindrical bore is internally threaded, and the closure member has an externally threaded portion, configured to threadably mate with the internally threaded portion of the region of the second portion of the cylindrical bore.
